(19) United States
(12) Patent Application Publication
(10) Pub. No.: US 2018/0196538 A1
(43) Pub. Date: Jul. 12, 2018

(54) METHOD FOR MANUFACTURING TOUCH SCREEN, TOUCH SCREEN AND DISPLAY DEVICE

(71) Applicants: BOE Technology Group Co., Ltd., Beijing (CN); HEFEI XINSHENG OPTOELECTRONICS TECHNOLOGY CO., LTD., Anhui (CN)

(72) Inventors: Xujie ZHANG, Beijing (CN); Ming ZHANG, Beijing (CN); Qitao ZHENG, Beijing (CN); Guiyu ZHANG, Beijing (CN); Jian TIAN, Beijing (CN); Jing WANG, Beijing (CN)

(21) Appl. No.: 15/843,474

(22) Filed: Dec. 15, 2017

(30) Foreign Application Priority Data
Jan. 9, 2017 (CN) 201710013038.6

(51) Int. Cl. G06F 3/041; B05D 3/00

(52) U.S. Cl. CPC G06F 3/041; G06F 2203/04103; B05D 3/007

(57) ABSTRACT

Here provides a method for manufacturing a touch screen, a touch screen and a display device. The method comprises: Step S10: performing modification to a surface of a substrate, so as to make the substrate surface having hydrophilicity; and Step S11: printing a graphene-nanosilver composite paste on the modified surface of the substrate by an ink-jet printing method to form a grid touch electrode. The graphene-nanosilver composite touch electrode has a smaller wire width, thereby having a lower sheet resistance, a higher flexibility and a lower manufacture cost. The method can improve the accuracy of the manufacture of a touch electrode and obtain a relatively larger gird width, thus obtaining a higher light transmittance. Moreover, the adhesion of the graphene-nanosilver composite to the substrate surface can be increased, and the electrical conductivity of the touch electrode can be enhanced and the circuit break is less likely to occur.

### CROSS REFERENCE TO RELATED APPLICATIONS

This application claims the benefit of Chinese Patent Application No. 201710013038.6, filed on Jan. 9, 2017, entitled “Method for Manufacturing Touch Screen, Touch Screen and Display Device”, which is hereby incorporated by reference in its entirety into this application.

### TECHNICAL FIELD

The present disclosure relates to the field of display technology, particularly to a method for manufacturing a touch screen, a touch screen and a display device.

### BACKGROUND

The conventional flexible touch screens typically use ITO (indium tin oxide) metal oxide thin film as a touch electrode thereof, which greatly limits its application in flexible electronic devices due to the ceramic brittleness of the ITO thin film. In addition, the brittleness of the ITO thin film also increases the cost during manufacture, transportation and operation.

Presently, with the development of nanometer technology, a new generation of transparent electrode materials such as silver nanowire, carbon nanotube, graphene, conductive polymer and the like gradually broadens its application in the flexible electronic devices and is expected to replace the ITO transparent electrode.

### SUMMARY

The metal nanowire transparent electrode generally has a grid structure, wherein gaps between the metal wires are completely light transparent and the metal wire itself is almost light tight, so the area percent of the metal wire relative to the grid structure determines the transmittance of the whole metal grid electrode. The sheet resistance of the metal grid electrode depends on the width and thickness of the metal wire. Although the sheet resistance of the metal grid electrode can be reduced by increasing the thickness of the metal wire, the roughness and the process difficulty of the metal grid electrode would be increased accordingly. Therefore, one of the effective ways to solve the problems of transmittance and sheet resistance of the metal grid electrode is making the wire width of the metal grid electrode thinner. Moreover, the adhesion of the metal nanowire transparent electrode to the touch screen substrate is usually low, so under the effect of the bending stress of the flexible touch screen, the metal nanowire transparent electrode is easily peeled off from the substrate, which would affect the touch performance of the touch screen.

Currently, in order to improve the transmittance of the metal grid electrode and reduce the sheet resistance thereof, how to make the wire width of the metal grid electrode thinner is becoming a problem which needs to be solved urgently.

In order to overcome the above-mentioned technical problems in the prior art, the present disclosure provides a method for manufacturing a touch screen; a touch screen resulted by the method and a display device comprising the touch screen. The graphene-nanosilver composite touch electrode obtained by the method has a smaller wire width, thereby having a lower sheet resistance, a higher flexibility and a lower manufacture cost. The method can improve the accuracy of the manufacture of the touch electrode and obtain a relatively larger gird width, thus obtaining a higher light transmittance. Moreover, the adhesion of the graphene-nanosilver composite to the substrate can be increased, and the electrical conductivity of the touch electrode formed by printing the graphene-nanosilver composite material can be enhanced, therefore the circuit break is less likely to occur.

The present disclosure provides a method for manufacturing a touch screen, comprising:

Step S10: performing modification to a surface of a substrate, so as to make the substrate surface having hydrophilicity; and

Step S11: printing a graphene-nanosilver composite paste on the modified surface of the substrate resulted in the Step S10 by an ink-jet printing method to form a grid touch electrode.

Preferably, the Step S10 comprises:

Step S101: applying a hydrophilic silicone antifogging transparent coating on a substrate made of polyurethane material; and

Step S102: curing the hydrophilic silicone antifogging transparent coating at 90° C. to 110° C.

Preferably, in the Step S101, the thickness of the cured hydrophilic silicone antifogging transparent coating is 1 μm to 3 μm.

Preferably, the Step S11 comprises:

Step S111: preparing nanosilver particles;

Step S112: preparing a graphene-nanosilver composite paste;

Step S113: printing the graphene-nanosilver composite paste on the modified surface of the substrate resulted in the Step S102 by an ink-jet printing method, so as to obtain a grid-like pattern by printing; and

Step S114: calcining the substrate resulted in the Step 5113 at 80° C. to 120° C. to evaporate a solvent in the graphene-nanosilver composite paste, so as to form a pattern of a touch electrode, which has a wire width of 3 μm or more and 5 μm or less.

Preferably, the Step S111 comprises:

firstly dissolving 8 g to 12 g polyvinylpyrrolidone in 80 ml to 100 ml ethylene glycol, and then adding 2.0 g to 2.5 g silver nitrate therein;

placing the above mixture in an oil bath at 50° C. to 70° C. and stirring until the silver nitrate is completely dissolved, and raising the temperature of the oil bath up to 100° C. to 120° C. and then maintaining at the temperature of 100° C. to 120° C. to react for 1 to 1.5 h;

cooling the temperature of the reaction system after the reaction completed to room temperature, during this course the nanosilver particles separating therefrom; and

drying the resulted nanosilver in vacuum at 50° C. to 70° C. for 0.5 to 1 h to obtain the nanosilver particles.

Preferably, the Step S112 comprises:

firstly formulating the nanosilver particles into a conductive silver paste ink having a silver content of 0.2 wt % to 4 wt %;

preparing a dispersion containing water, ethanol, graphene and dispersing agent, and adding the dispersion into the conductive silver paste ink, wherein the mass ratio of graphene in a mixture of the dispersion and the conductive silver paste ink is 0.2% to 0.5%; and

putting the mixture in a ultrasonic vibrator and vibrating the mixture to make it sufficiently dispersed.

Preferably, in the Step S113, the grid width of the pattern formed by printing is 50 nm to 60 nm.

The present disclosure also provides a touch screen manufactured by the above method, which comprises a substrate and a touch electrode formed on the substrate, wherein the substrate has a modified surface with hydrophilicity, the touch electrode is made of a graphene-nanosilver composite material, and the touch electrode has a grid structure.

Preferably, the substrate is made of polyurethane and has a hydrophilic silicone antifogging transparent coating on at least one surface of the substrate, and the wire width of the touch electrode is 3 μm or more and 5 μm or less.

The present disclosure further provides a display device including the above touch screen.

The present disclosure has the following advantageous effects: in the method for manufacturing the touch screen according to the present disclosure, the modified surface of the substrate can have hydrophilicity by the modification treatment, and by printing the graphene-nanosilver composite paste on the hydrophilic surface of the substrate, a metal grid with a wire width of 3 μm or more and 5 μm or less can be formed under the “coffee ring” effect. In comparison with the ITO (indium tin oxide) conductive layer prepared from the conventional photo process, the graphene-nanosilver composite touch electrode obtained from the present method has a smaller wire width, so that the touch electrode has a lower sheet resistance and a higher flexibility. Meanwhile, the manufacture cost is remarkably reduced, and the process accuracy of the touch electrode is improved. Moreover, in the case where the grid density is certain, a relative larger grid width can be obtained according to the present method, thereby a higher light transmittance can be achieved compared with that of the touch screen prepared from the conventional ink-jet printing method. In addition, since the hydrophilicity of the modified surface of the substrate is highly improved, the adhesion of the graphene-nanosilver composite to the substrate surface can be enhanced. Further, because the graphene with laminated structure has carrying and linking effect as well as electric conductivity, the dispersed nanosilver particles mixed therein can be well linked together through graphene, the electrical conductivity of the touch electrode formed by printing the graphene-nanosilver composite material is much better, which further make the circuit break less likely to occur.

In the display device provided by the present disclosure comprising the touch screen manufactured by the method according to the present disclosure, not only increases the light transmittance of the display device, but also improves the touch performance of the display device.

### DESCRIPTION OF THE FIGURES

FIG. 1 schematically showing Step S101 according to example 1 of the present disclosure;

FIG. 2 schematically showing the principle of “coffee ring” effect according to example 1 of the present disclosure;

FIG. 3 schematically showing Step S113 according to example 1 of the present disclosure;

FIG. 4 schematically showing the solvent evaporation process of step S114 according to example 1 of the present disclosure;

FIG. 5 schematically showing the pattern of touch electrode formed in step S114 according to example 1 of the present disclosure;

FIG. 6 schematically showing the cross section of the touch screen obtained according to example 2 of the present disclosure.

Wherein, the references are as below:

1. Substrate 2. Hydrophilic Silicone antifogging transparent coating

3. Graphene-nanosilver composite paste 4. Touch electrode.

### DETAILED DESCRIPTION OF EMBODIMENTS

The method for manufacturing a touch screen, the resulted touch screen and a display device comprising such touch screen according to the present disclosure will be further described in detail with reference to the accompanying drawings and specific embodiments in order to provide a better understanding of the technical solutions of the present disclosure.

The present embodiment provides a method for manufacturing a touch screen, comprising:

Step S10: performing modification to a surface of a substrate, so as to make the substrate surface having hydrophilicity.

Specifically, this step comprises:

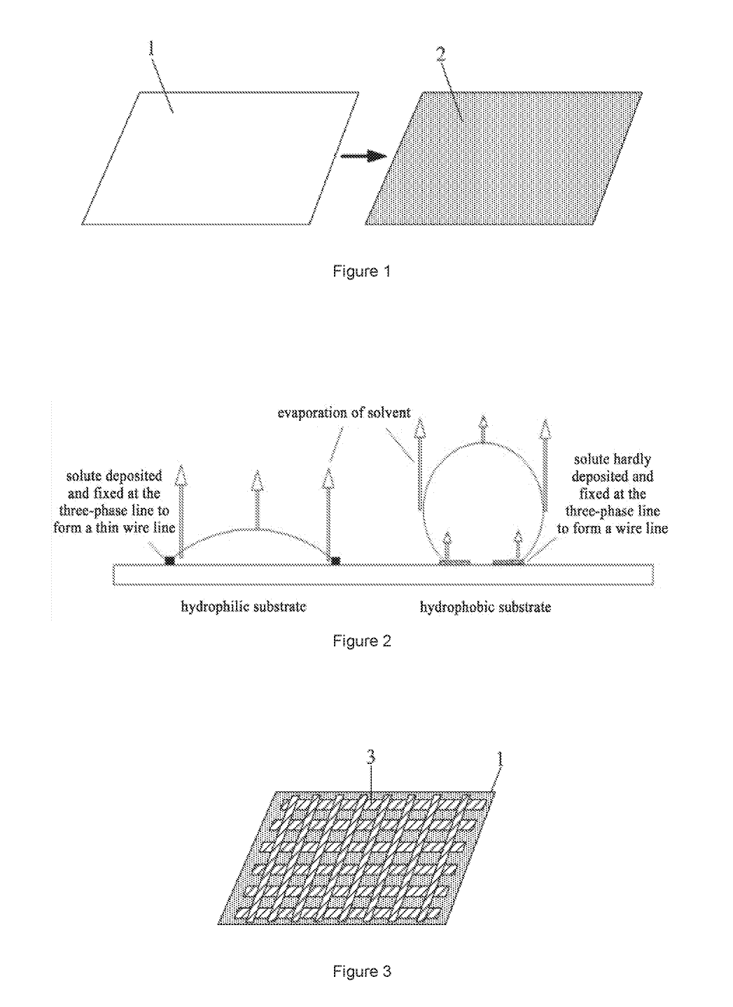

Step S101: applying a hydrophilic silicone antifogging transparent coating 2 on a substrate 1 made of polyurethane material (PET), as shown in FIG. 1.

Step S102: curing the hydrophilic silicone antifogging transparent coating 2 at 90° C. to 110° C.

The silicone antifogging transparent coating comprises (Epoxypropoxypropyl)trimethoxysilane, polyethylene glycol, ethyl orthosilicate, leveling agent, curing agent and nano ATO.

The thickness of the cured hydrophilic silicone antifogging transparent coating 2 is 1 μm to 3 μm.

It should be noted that, the substrate 1 may use other polymer transparent flexible materials such as PMMA (i.e. polymethyl methacrylate), PVC (i.e. polyvinyl chloride) and the like.

A surface of the substrate 1 is modified by means of applying the hydrophilic silicone antifogging transparent coating 2, the hydrophilicity of the surface of the polymer transparent flexible substrate 1 which originally has hydrophobic can be increased, thereby contributing to the formation of touch electrode pattern with smaller wire width on the hydrophilic substrate 1 under the “coffee ring” effect. The “coffee ring” effect refers to that, when the solvent contained in the liquid drop evaporates, the solute in the liquid drop would deposit a ring at the edge of the liquid drop whose color is much deeper than that in the middle of the liquid drop. As shown in FIG. 2, the hydrophilicity of the surface of the substrate 1 is better, the contact angle between the liquid drop and the substrate 1 is smaller, and the evaporation rate of the solvent in the liquid drop at three-phase line (i.e. the contact point of the substrate, the liquid drop and the gas phase which comprise air and the vapor evaporated from the liquid drop) is higher, so the solute in the liquid drop can be quickly deposited and fixed at the three-phase line, thus ultimately forming a more slender wire line. Otherwise, if the hydrophobicity of the surface of the substrate 1 is higher, the contact angle between the liquid drop and the substrate 1 is bigger, and the evaporation rate of the solvent in the liquid drop at three-phase line is slower, so the deposition rate and fixation rate of the solute in the liquid drop at three-phase line are lower, and it is hardly to form a wire line finally. Meanwhile, since the hydrophilicity of the modified surface of the substrate 1 is improved, the adhesion of the graphene-nanosilver composite, which is subsequently printed on the modified surface of the substrate 1, to the substrate 1 can be increased, thus improving the touch performance of the resulted touch screen. Moreover, because the light can be transmitted normally through the hydrophilic silicone antifogging transparent coating 2, the light transmittance of the substrate 1 would be not affected.

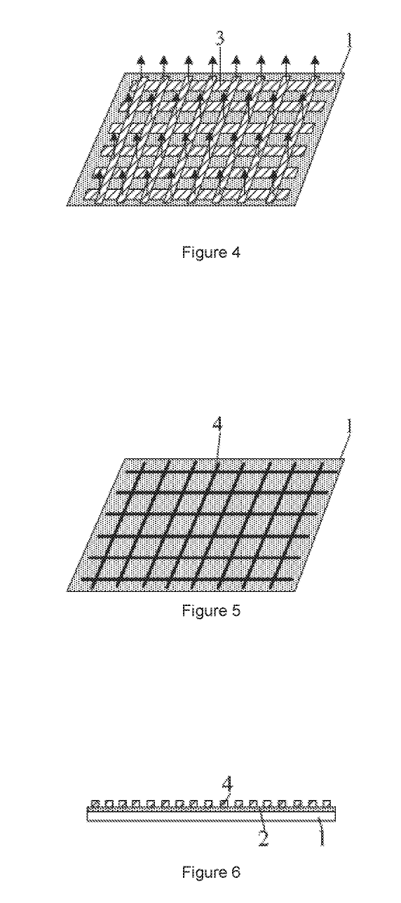

Step S11: printing a graphene-nanosilver composite paste 3 on the modified surface of the substrate resulted in the Step S10 by an ink-jet printing method to form a grid touch electrode 4, as shown in FIGS. 3 to 5.

Specifically, this step comprises:

Step S111: preparing nanosilver particles.

Particularly, the above step comprises: firstly, dissolving 8 g˜12 g polyvinylpyrrolidone in 80 mL˜100 mL ethylene glycol, and then adding 2.0 g˜2.5 g silver nitrate therein; placing the above solution in an oil bath at 50° C.˜70° C. and stirring until silver nitrate is completely dissolved; then raising the temperature of the oil bath up to 100° C.˜120° C. and maintaining at the temperature of 100° C.˜120° C. to react for 1˜1.5 h; cooling the temperature of the solution after reaction to room temperature, so that the nanosilver particles are separated from the solution; thereafter drying in vacuum at 50° C.˜70° C. for 0.5˜1 h to obtain the nanosilver particles.

Step S112: preparing a graphene-nanosilver composite paste.

Particularly, the above step comprises: firstly, formulating the nanosilver particles into a conductive silver paste ink having a silver content of 0.2˜4 wt %; then preparing a dispersion solution containing water, ethanol, graphene and dispersing agent, and adding the dispersion solution into the conductive silver paste ink, wherein the mass ratio of graphene in the mixture solution of the dispersion solution and the conductive silver paste ink is 0.2%˜0.5%; and placing the mixture solution in a ultrasonic vibration instrument and vibrating so as to be sufficiently dispersed.

Step S113: printing the graphene-nanosilver composite paste 3 on the modified surface of the substrate 1 resulted in the Step S102 by an ink-jet printing method so as to obtain a grid-like pattern, as shown in FIG. 3.

The grid width formed by printing in Step 113 is 50 nm to 60 nm.

Step S114: calcining the substrate 1 resulted in the Step S113 at 80° C. to 120° C. to evaporate a solvent in the graphene-nanosilver composite paste 3, so as to form a pattern of a touch electrode 4, which has a wire width of 3 μm or more and 5 μm or less, as shown in FIG. 5.

As shown in FIG. 6, the touch screen obtained from the above embodiment comprises a substrate 1 and a touch electrode 4 formed on the substrate 1, wherein the substrate 1 has a hydrophilic silicone antifogging transparent coating on one surface thereof, the touch electrode 4 is made of a graphene-nanosilver composite material and has a grid structure.

The hydrophilic silicone antifogging transparent coating 2 could provide the hydrophobic substrate 1 with a good hydrophilicity, thus the graphene-nanosilver composite paste can form a wire line with smaller wire width on the substrate 1 by an ink-jet printing method under the “coffee ring” effect. The wire width of the resulted touch electrode 4 could reach 3 μm or more and 5 μm or less, which is smaller than that of the conductive layer obtained by the conventional process, so the touch electrode 4 has a lower sheet resistance and a higher flexibility. Meanwhile, the process accuracy of the touch electrode 4 is improved and the manufacture cost is greatly reduced.

Moreover, for a certain grid density, a smaller wine width means a larger grid width, thus the touch screen according to the present disclosure has a grid width of 150 μm or more. Compared with the conventional touch screen, a higher light transmittance can be achieved in the touch screen according to the present disclosure

Further, the improved hydrophilicity of the substrate surface makes the adhesion of the graphene-nanosilver composite to the substrate surface improved, and thus the touch electrode would not separated from the substrate under the effects of the outside or inside stresses which ensure a good quality of the touch screen.

In addition, by virtue of the laminated structure of graphene, it has carrying and linking effects with the dispersed nanosilver particles, thus the particles could be linked together better by graphene, which could further make the electrode made of the graphene-nanosilver composite has a better electrical conductivity and it is less likely to occur a circuit break.

Another embodiment of the present disclosure provides a display device including the touch screen of the above embodiment.

By using the said touch screen, not only the light transmittance of the display device can be increased, but also the touch performance of the display device can be improved.

The display device provided by the present disclosure can be any product or component having a display function such as a liquid crystal panel, a liquid crystal television, a display apparatus, a mobile phone, a navigator and the like.

It should be understood that the embodiments described above are merely the exemplary embodiments for the purpose of illustrating the principles of the present disclosure, which shall not limit the scope of the disclosure. Various changes and modifications to the present disclosure made without departing from the scope and spirit of disclosure by a person skilled in the art should all be covered in the protection scope of the present disclosure.

1. A method for manufacturing a touch screen, comprising:
Step S10: performing modification to a surface of a substrate, so as to make the substrate surface having hydrophilicity; and
Step S11: printing a graphene-nanosilver composite paste on the modified surface of the substrate by an ink-jet printing method to form a grid touch electrode.

2. The method for manufacturing a touch screen according to claim 1, characterized in that, the Step S10 comprises:
Step S101: applying a hydrophilic silicone antifogging transparent coating on a substrate made of polyurethane material; and
Step S102: curing the hydrophilic silicone antifogging transparent coating at 90° C. to 110° C.

3. The method for manufacturing a touch screen according to claim 2, characterized in that, the thickness of the cured hydrophilic silicone antifogging transparent coating is 1 μm to 3 μm.

4. The method for manufacturing a touch screen according to claim 1, characterized in that, the Step S11 comprises:
Step S111: preparing nanosilver particles;
Step S112: preparing a graphene-nanosilver composite paste;
Step S113: printing the graphene-nanosilver composite paste on the modified surface of the substrate by an ink-jet printing method, so as to obtain a grid-like pattern by printing; and
Step S114: calcining the substrate resulted in the Step S113 at 80° C. to 120° C. to evaporate a solvent in the graphene-nanosilver composite paste, so as to form a pattern of a touch electrode, which has a wire width of 3 μm or more and 5 μm or less.

5. The method for manufacturing a touch screen according to claim 4, characterized in that, the step S111 comprises:
firstly dissolving 8 g to 12 g polyvinylpyrrolidone in 80 ml to 100 ml ethylene glycol, and then adding 2.0 g to 2.5 g silver nitrate therein;
placing the above mixture in an oil bath at 50° C. to 70° C. and stirring until the silver nitrate is completely dissolved, and raising the temperature of the oil bath up to 100° C. to 120° C. and then maintaining at the temperature of 100° C. to 120° C. to react for 1 to 1.5 h;
cooling the temperature of the reaction system after the reaction completed to room temperature, during this course the nanosilver particles separating therefrom; and
drying the resulted nanosilver in vacuum at 50° C. to 70° C. for 0.5 to 1 h to obtain the nanosilver particles.

6. The method for manufacturing a touch screen according to claim 4, characterized in that, the step S112 comprises:
firstly formulating the nanosilver particles into a conductive silver paste ink having a silver content of 0.2 wt % to 4 wt %;
preparing a dispersion containing water, ethanol, graphene and dispersing agent, and adding the dispersion into the conductive silver paste ink, wherein the mass ratio of graphene in a mixture of the dispersion and the conductive silver paste ink is 0.2% to 0.5%; and
putting the mixture in a ultrasonic vibrator and vibrating the mixture to make it sufficiently dispersed.

7. The method for manufacturing a touch screen according to claim 4, characterized in that, in the step S113, the grid width of the pattern formed by printing is 50 nm to 60 nm.

8. A touch screen manufactured from the method according to claim 1, comprising a substrate and a touch electrode formed on the substrate, characterized in that, the substrate has a modified surface with hydrophilicity, the touch electrode is made of a graphene-nanosilver composite material, and the touch electrode has a grid structure.

9. The touch screen according to claim 8, characterized in that, the substrate is made of polyurethane material, the modified surface of the substrate has a hydrophilic silicone antifogging transparent coating, and the e width of the touch electrode is 3 μm or more and 5 μm or less.

10. A display device, characterized by including the touch screen according to claim 8.
